(19) United States
(12) Patent Application Publication
(10) Pub. No.: US 2009/0228363 A1
(43) Pub. Date: Sep. 10, 2009

(54) SHOPPING SYSTEM AND METHOD THEREFOR

(76) Inventor: Yaniv Segev, Modin (IL)

Correspondence Address: YORAM TSIVION, P.O. BOX 1307, PARDES HANNA, 37111, IL

(21) Appl. No.: 12/392,116

(22) Filed: Feb. 25, 2009

Related U.S. Application Data
(60) Provisional application No. 61/031,034, filed on Feb. 25, 2008.

(51) Int. Cl. G06Q 30/00; G08B 13/14; G06Q 20/00

(52) U.S. Cl. 705/16; 705/23; 340/572.1; 705/21; 705/17

(57) ABSTRACT

A shopping system for purchasing one or more goods comprising: at least one shopping cart into which items to be purchased are placed. The cart includes a quantity measurement mechanism to detect a measureable quantity parameter (e.g. weight or volume) of each good placed in the cart. The system further comprises a shopping environment in which goods are arranged in designated areas according to their price per quantity parameter; a mechanism for ensuring that goods placed in the cart are associated with the measurable quantity related to the good(s); and a payment collection arrangement.

### RELATED APPLICATIONS

This application claims the benefit of U.S. Provisional Patent Application 61/031,034, filed on 25 Feb. 2008 in the name of Yaniv SEGEV and entitled SHOPPING SYSTEM AND METHOD THEREFOR.

The content of the aforementioned provisional application is incorporated herein in its entirety by reference.

### FIELD OF THE INVENTION

The present invention relates to shopping, in particular a system therefor wherein the cost of an item to be purchased is determined by a quantity parameter such as the weight or volume of the item.

### BACKGROUND OF THE INVENTION

Shopping, at a supermarket for example, can be a time consuming and frustrating experience as much time can be spent waiting in line to pay for purchases.

Accordingly, it is an object of the present invention to provide a shopping system and method that is quick and convenient.

### SUMMARY OF THE INVENTION

According to one aspect, the present invention relates to a shopping system wherein the cost of an item to be purchased is determined by a quantity measurement such as the weight or volume of the item. For the sake of convenience, the term “weight” may be used interchangeably with the term “quantity measurement” or “quantity parameter” herein the specification and claims.

Accordingly, the present invention provides a shopping system comprising a store and a shopping cart adapted to provide shopping by a quantity parameter. In other words, the items for sale are priced in relation to their weight or volume; or any other measureable parameter, and/or their specific category/type, there being a specific price per weight for each good or category of goods (e.g. candy, perfume, breakfast cereal, etc). Goods/items of a particular category are typically located in the same area of the store; however items of different categories may be located in the same area of the store if they have the same category price (price per weight). There is essentially no limit to the type of item that can be purchased in this manner, in accordance with the present invention.

The present invention provides a system and method of shopping as understood from the following components and description:

1) Products in a retail or commercial facility (hereinafter store”) belong to various groups or categories, wherein for each group there is a specific price per quantity parameter (e.g. weight).

2) A shopping cart adapted to allow for shopping for goods on the basis of the quantity parameter of those goods.

3) In different areas of the store the shopping (price) system will set the cost per quantity parameter of the items in that area according to the group of products and/or their location.

4) When a product is put in the shopping cart in a specific area in store, it will be measured and on the basis of its quantity parameter measurement the cart will automatically account for the purchase.

5) The shopper will have the possibility to see the quantity parameter measurement of the purchase and the price on a cart-mounted screen prior to deciding whether to make the purchase.

6) The shopping cart will typically be able to independently debit the purchase via a credit card or other form of payment.

7) The price of a category of products/goods will be set as a price per quantity parameter of the finished product for the customers, which includes the packaging of the item, so that it can be measured and a price/cost is determined. For example, all the perfumes in the store may be set at a price of $1 per gram of the gross item (i.e. not merely the weight, for example, of the perfume inside the packaging, rather including any bottle/container and outer packaging if any). The cost for sweets and candy may be, for example, 10 cents per gram.

8) The shopping cart will be designed so that the shopping system can identify the cart's physical location such that the cart will be able to determine the price per quantity parameter of the item while the cart is in a particular location in the store, in an area where there is a set price per quantity parameter, typically adjacent to where the goods are positioned for sale. In other words, in one aisle of the store, or portion of an aisle, there may be perfumes which the cart knows to be priced at $1 per gram, while in another location, where candy is displayed for sale, the cart knows that the price is 10 cents per gram. When a shopper places a candy in the cart in that area of the store, the candy is measured, for example, weighed, and the weight and price are displayed for the shopper.

9) The store will typically further comprise a mechanism to inform the shopper upon moving a product outside “its area” prior to placing it in the shopping cart. This mechanism can be similar to an anti-theft alarm of the type that is sounded when a tagged item is removed from a store without paying (without first removing or neutralizing the tag).

### BRIEF DESCRIPTION OF THE DRAWINGS

The invention may be understood upon reading of the following detailed description of non-limiting exemplary embodiments thereof, with reference to the following drawings, in which:

FIG. 1 is a shopping cart according to an embodiment of the shopping system of the present invention;

FIG. 2 is a schematic perspective view of a store according to an embodiment of the shopping system of the present invention; and

FIG. 3 is a schematic perspective view of a side of a store aisle according to another embodiment of the shopping system of the present invention.

### DESCRIPTION OF EMBODIMENTS OF THE INVENTION

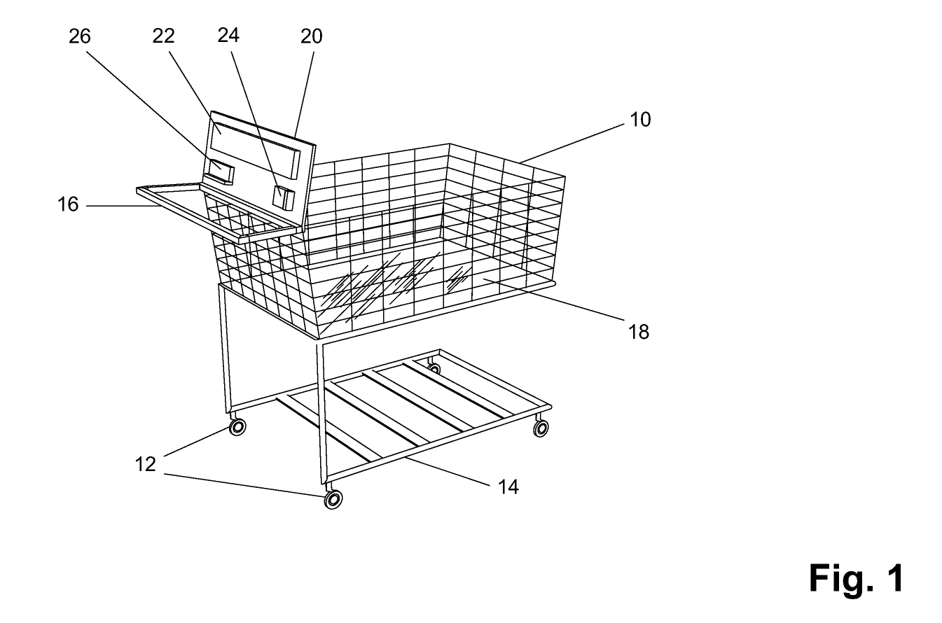

FIG. 1 illustrates an exemplary shopping cart allowing for the purchase of products in a store on the basis of weight as provided by the shopping system of the present invention. The shopping cart comprises a number of components common to most shopping carts including a basket 10 where items to be purchased are disposed during shopping, a set of wheels 12, typically attached to a base portion 14, and a handle 16 to grasp and push the cart. The shopping cart of the present invention further comprises a product weight-sensing device 18, for example, an electronic scale. Several publications disclose examples of appropriate weight-sensing devices, including U.S. Pat. No. 3,836,755, U.S. Pat. No. 4,071,740 and U.S. Pat. No. 6,725,206. Weight-sensing device 18 is typically located all along the bottom of basket 10.

The shopping cart further comprises a payment device 20 with a display 22 (operably connected to weight-sensing device 18) to inform the shopper of details of the product which at least include its weight and its price (and price per weight). The payment device 20 may be more sophisticated and include additional features, for example, identification of the product purchased (e.g. via an RF tag or bar code), consumer information such as the location of complimentary goods or sale products, and so on.

The payment device 20 also comprises a payment collection mechanism 24, for example a credit card slot; and/or a cash slot for accepting bills and coins and providing change; and/or a payment voucher slot, coupon slot and the like. If payment is by credit card, the collection mechanism may comprise a credit card owner verification/identification system 26 (e.g. a signature pad, finger print check system, retina check, etc).

Alternatively, payment collection can be conveniently performed without using the shopping cart. For example, after the shopper has completed his/her purchases, he/she can go to a location where a cashier merely takes/verifies payment. All of the purchases will have already been totaled by the payment device 20 and so this procedure will take little time.

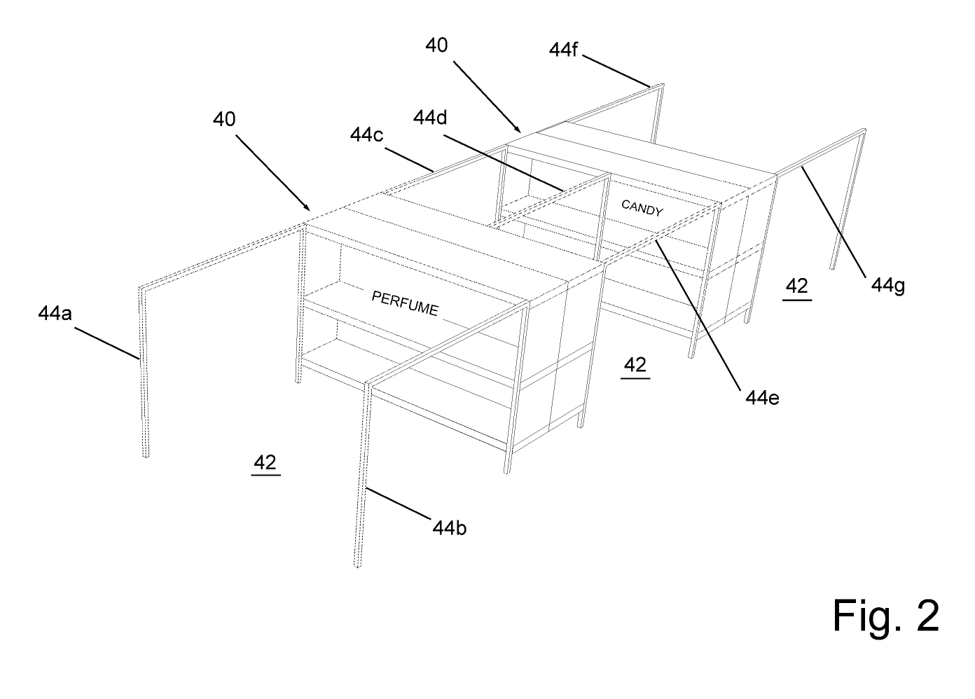

FIG. 2 shows a schematic view of an exemplary store for use with an embodiment of the shopping system of the present invention. The store comprises a number of display modules 40 and aisles 42. At various locations there are gates 44a-44g disposed at the ends of pre-determined category areas (as described above) to separate between those areas. According to particular embodiments, these gates 44a-44g are adapted to be readily moveable in order to provide flexibility in defining the size and location of the category areas. For example, a first category area where perfume is displayed for sale is defined by gates 44a and 44b; and a second category area defined by gates 44c and 44d defines an area where candy is displayed for sale.

To shop, a shopper can move his/her shopping cart down aisle 42 to a particular category area, for example where perfume is sold (i.e. between gates 44a and 44b), select a perfume and put it in basket 10 (i.e. on weight-sensing device 18) of the cart. This will cause the perfume to be weighed and this weight and/or the price of the perfume will be displayed on display 22. The shopper may remove the perfume if he/she decides not to purchase it and continue shopping, else it will automatically be tallied as an intended purchase.

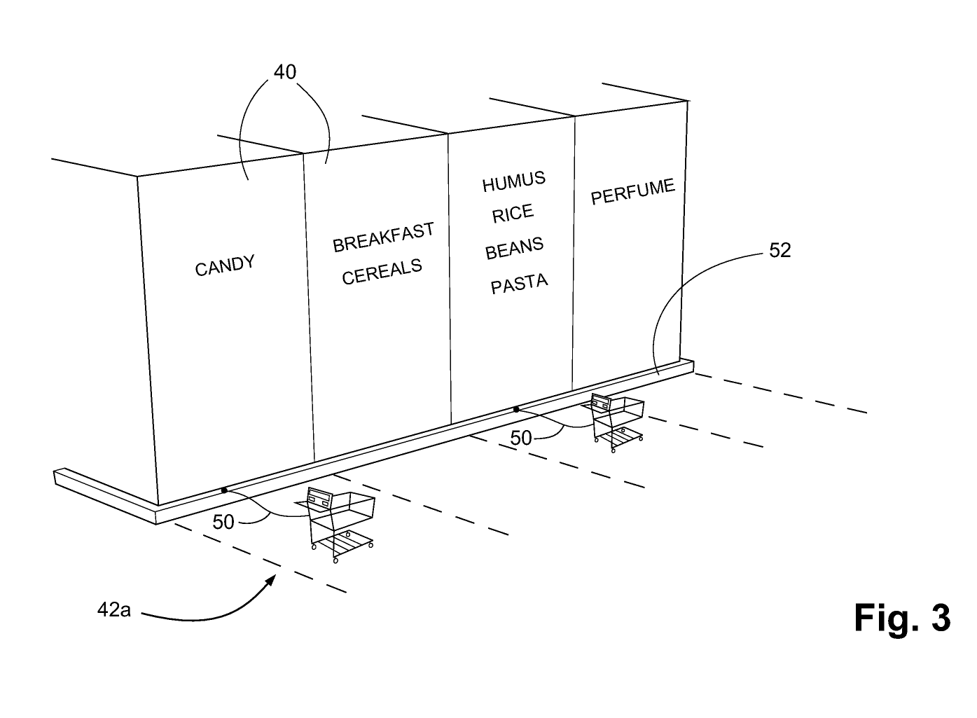

FIG. 3 shows a schematic view of one side of an aisle 42a of another exemplary store for use with an embodiment of the shopping system of the present invention. Here there are a number of display modules 40 and the location of the cart is known due to a cable 50 connected to a track 52 along the bottom of the display modules 40. The position of the cart can then be transferred to a central computer (not shown), which thereby provides the price per weight of the items for sale in any particular area of the store. It should be understood that the location of the cart can be identified by any appropriate technology (RF tags, GPS and so on).

At the completion of the shopping, the shopper can pay for the items in the cart, for example, with a credit card via payment collection mechanism 24. Typically if payment is by credit card, the credit card owner will be required to provide some verification or identification that he/she is indeed the credit card owner, for example via credit card owner verification/identification system 26.

In accordance with other embodiments, the purchases can be paid for at more centralized location, for example, by a cashier or payment machine. As the purchases have already been tallied, there is no need for bar codes or removing the purchases from the cart in order to “ring up” the purchases.

It should be understood that the above description is merely exemplary and that there are various embodiments of the present invention that may be devised, mutatis mutandis, and that the features described in the above-described embodiments may be used separately or in any suitable combination. For example, the measured quantity parameter used to price the goods could be the volume of the good, measured by any appropriate means; or any other measureable parameter related to the quantity of the goods.

In an alternative to items being located in particular areas according to their cost per weight (or other measureable quantity parameter), the goods comprise an identifier (e.g. bar code, RFID tag) that can be used to identify the product and thus classify it in a particular price per weight and/or category.

1. A shopping system for purchasing one or more goods comprising:
at least one shopping cart into which items to be purchased are placed, said at least one shopping cart including a quantity measurement mechanism to detect a measureable quantity parameter of each of said goods placed in the shopping cart;
a shopping environment in which goods are arranged in designated areas according to their price per quantity parameter;
a mechanism for ensuring that goods placed in said cart are associated with said measurable quantity related to that or those goods;
a payment collection arrangement for attending to payment of said goods placed within said cart,
whereby goods placed for purchase can be placed in said shopping cart and measured according to said measureable quantity parameter by said quantity measurement mechanism, the goods being priced according to said measureable quantity parameter.

2. A shopping system according to claim 1, wherein the measureable quantity parameter is the weight of the good.

3. A shopping system according to claim 1, wherein the measureable quantity parameter is the volume of the good.

4. A shopping system according to claim 1, wherein the payment device is associated with the shopping cart.

5. A shopping system according to claim 1, wherein payment for the goods is made at a centralized location.

6. A shopping system according to claim 1, wherein the shopping environment is defined or controlled by a wireless locating system

7. A shopping system according to claim 6, wherein the wireless locating system comprises a global positioning system.

8. A shopping system according to claim 6, wherein the wireless locating system uses an RFID tag.

9. A shopping system according to claim 1, wherein the shopping environment is defined or controlled by gates defining pre-determined category or price per quantity parameter areas.

10. A shopping cart for purchasing one or more goods comprising:
a portion for placing said goods;
a quantity measurement mechanism to detect a measureable quantity parameter of each of said goods placed in the shopping cart;
a mechanism for ensuring that goods placed in the cart are associated with said measurable quantity related to that or those goods;
a payment device for attending to payment of said goods placed within said cart,
whereby goods placed for purchase can be placed in said shopping cart and measured according to said measureable quantity parameter by said quantity measurement mechanism, the goods being priced according to said measureable quantity parameter.

11. A method of shopping comprising the steps of:
positioning a shopping cart in a predefined shopping category area wherein goods in said shopping category are priced according to a predetermined quantity parameter;
placing one or more goods for purchase in said shopping cart within said predefined shopping category area, whereby the goods are priced; and
attending to payment of said goods.

12. A method of shopping according to claim 11, wherein attending to payment of said goods comprises using a payment device associated with the shopping cart.
